(19) United States
(12) Patent Application Publication
(10) Pub. No.: US 2026/0331110 A1
(43) Pub. Date: Oct. 22, 2026

(54) METHODS AND SYSTEMS FOR PROCESSING REQUEST USING ARTIFICIAL INTELLIGENCE ASSISTANT DEVICE BASED ON LARGE LANGUAGE MODEL

(71) Applicant: NAVER CORPORATION, Seongnam-si (KR)

(72) Inventors: Jun Hyung PARK, Seongnam-si (KR); Daeyoung LEE, Seongnam-si (KR); Mun Young HWANG, Seongnam-si (KR); Kwan Seok KIM, Seongnam-si (KR)

(73) Assignee: NAVER CORPORATION, Seongnam-si (KR)

(21) Appl. No.: 19/265,613

(22) Filed: Jul. 10, 2025

(30) Foreign Application Priority Data
Apr. 18, 2025 (KR) 10-2025-0051038

(51) Int. Cl. G10L 15/26; G10L 17/02

(52) U.S. Cl. CPC G10L 15/26; G10L 17/02

(57) ABSTRACT

Disclosed is a method and system for processing a request using an artificial intelligence (AI) assistant device based on a large language model. A request processing method may include processing an audio signal input through a microphone, recognizing a first voice in the audio signal, storing first audio data or first text data in a buffer, the first audio data or the first text data being related to the first voice, recognizing a second voice in the audio signal, and transmitting second audio data or second text data together with the first audio data or the first text data to a large language model platform in response to the recognizing the second voice, the second audio data or the second text data being related to the second voice.

### CROSS-REFERENCE TO RELATED APPLICATION(S)

This U.S. non-provisional application claims the benefit of priority under 35 U.S.C. § 119 to Korean Patent Application No. 10-2025-0051038 filed on Apr. 18, 2025, in the Korean Intellectual Property Office (KIPO), the entire contents of which are incorporated herein by reference.

### BACKGROUND

### Technical Field

Some example embodiments of the following description relate to a method and system for processing a request using an artificial intelligence assistant device based on a large language model.

### Description of Related Art

An artificial intelligence assistant device, such as an Artificial Intelligence (AI) assistant speaker, transmits an audio voice to a server after a specific keyword is recognized. The server provides a service based on a Large Language Model (LLM) to generate and provide an answer to a question included in the audio voice, and may not utilize a context of conversation spoken before the specific keyword is recognized.

Also, conventional audio-based LLM services focus on a 1:1 conversation mode, and are lacking in application to a stationary device such as a speaker. In addition, current audio-based LLM services need to transmit (or function by transmitting) all voices to a server, which may lead to privacy and cost issues. For example, users may be sensitive to privacy issues regarding their voices being leaked outside of the speaker (e.g., to the server).

Also, to apply an LLM to a speaker and an artificial intelligence assistant device, all recognized voices are transmitted to a server and then processed using the LLM, which may cause cost issues related to Graphics Processing Unit (GPU) use.

### BRIEF SUMMARY

Some example embodiments provide a method and system for processing a request using an artificial intelligence assistant device based on a large language model.

According to some example embodiments, there is provided a request processing method of a request processing system, the request processing system being implemented by at least one computer device, the at least one computer device including at least one processor, and the request processing method including processing, by the at least one processor, an audio signal input through a microphone, recognizing, by the at least one processor, a first voice in the audio signal, storing, by the at least one processor, first audio data or first text data in a buffer, the first audio data or the first text data being related to the first voice, recognizing, by the at least one processor, a second voice in the audio signal, and transmitting, by the at least one processor, second audio data or second text data together with the first audio data or the first text data to a large language model platform in response to the recognizing the second voice, the second audio data or the second text data being related to the second voice.

According to an aspect, the storing may include storing the first audio data in the buffer, and the transmitting may include transmitting the second audio data and the first audio data to a server over a network, the server including the large language model platform.

According to an aspect, the server may be configured to convert each of the first audio data and the second audio data to text using speech-to-text (STT) to obtain converted text, input the converted text to the large language model platform to process a request of a user according to a context, the request of the user corresponding to the second audio data, and the context corresponding to the first audio data, generate processing results according to processing the request of the user, and provide the processing results to the at least one computer device over the network.

According to an aspect, the storing may include converting the first audio data to text using STT to generate the first text data, and storing the first text data in the buffer, and the transmitting may include converting the second audio data to text using the STT to generate the second text data, and transmitting the second text data and the first text data to a server over a network, the server including the large language model platform.

According to an aspect, the server may be configured to input the first text data and the second text data to the large language model platform to process a request of a user according to a context, the request of the user corresponding to the second text data, and the context corresponding to the first text data, and generate processing results according to processing the request of the user, and provide the processing results to the at least one computer device over the network.

According to an aspect, the large language model platform may be included in the at least one computer device, the storing may include converting the first audio data to text using STT to generate the first text data, and storing the first text data in the buffer, and the transmitting may include converting the second audio data to text using the STT to generate the second text data, and transmitting the second text data and the first text data to the large language model platform.

According to an aspect, the request processing method may further include inputting, by the at least one processor, the first text data and the second text data to the large language model platform to process a request of a user according to a context, the request of the user corresponding to the second text data, and the context corresponding to the first text data, generating, by the at least one processor, processing results according to processing the request of the user, and outputting the processing results through a speaker.

According to an aspect, the request processing method further may include periodically removing from the buffer, a subset of the first audio data or a subset of the first text data that has been stored in the buffer beyond a certain period of time.

According to an aspect, the request processing method further may include removing the first audio data or the first text data from the buffer in response to the transmitting.

According to an aspect, the storing may include storing the first text data in the buffer, the request processing method may further include analyzing the first text data to identify third text data including at least one of context or an utterer, and extracting a subset of the third text data related to the second text data, and the transmitting may include transmitting the second text data and the subset of the third text data to the large language model platform.

According to an aspect, the recognizing the second voice may include recognizing a voice that includes a set keyword in the audio signal as the second voice, and the transmitting may include transmitting the second audio data or the second text data from which the set keyword is removed to the large language model platform.

According to some example embodiments, there is provided a non-transitory computer-readable recording medium storing instructions that, when executed by at least one processor, cause the at least one processor to execute the method on the computer device.

According to some example embodiments, there is provided a request processing system implemented by at least one computer device, the at least one computer device including at least one processor configured to cause the request processing system to process an audio signal input through a microphone, recognize a first voice in the audio signal, store first audio data or first text data in a buffer, the first audio data or the first text data being related to the first voice, recognize a second voice in the audio signal, and transmit second audio data or second text data together with the first audio data or the first text data a large language model platform in response to recognizing the second voice, the second audio data or the second text data being related to the second voice.

According to an aspect, the at least one computer device may include a speaker configured to cause the request processing system to convert a voltage signal into sound waves, the voltage signal being obtained based on an output of the large language model platform corresponding to the second audio data or the second text data and the first audio data or the first text data, and the sound waves being representative of an output audio signal corresponding to the output of the large language model platform.

According to some example embodiments, it is possible to provide a method and system for processing a request using an artificial intelligence assistant device based on a large language model.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Some example embodiments will be described in more detail with regard to the figures, wherein like reference numerals refer to like parts throughout the various figures unless otherwise specified, and wherein:

FIG. 1 is a diagram illustrating an example of a network environment according to some example embodiments;

FIG. 2 is a block diagram illustrating an example of a computer device according to some example embodiments;

FIGS. 3 to 5 illustrate examples of an internal configuration of a request processing system according to some example embodiments; and

FIG. 6 is a flowchart illustrating an example of a request processing method of a request processing system according to some example embodiments.

It should be noted that these figures are intended to illustrate the general characteristics of methods and/or structure utilized in some example embodiments and to supplement the written description provided below. These drawings are not, however, to scale and may not precisely reflect the precise structural or performance characteristics of any given example, and should not be interpreted as defining or limiting the range of values or properties encompassed by some example embodiments.

### DETAILED DESCRIPTION

Some example embodiments will be described in detail with reference to the accompanying drawings. Some example embodiments, however, may be embodied in various different forms, and should not be construed as being limited to only the illustrated examples. Rather, the illustrated examples are provided so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as, or a similar meaning to, that commonly understood by one of ordinary skill in the art to which some example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, contemporaneously, or in some cases be performed in reverse order.

Units and/or devices according to some example embodiments may be implemented using hardware and/or a combination of hardware and software. For example, hardware devices may be implemented using processing circuitry such as, but not limited to, a processor, Central Processing Unit (CPU), a controller, an Arithmetic Logic Unit (ALU), a graphics processing unit (GPU), a digital signal processor, a microcomputer, a Field Programmable Gate Array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or non-transitory computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to some example embodiments, computer processing devices may be described as including various functional units that perform various operations and/or functions to increase the clarity of the description. However, computer processing devices are not intended to be limited to these functional units. For example, in some example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to some example embodiments may also include one or more storage devices. The one or more storage devices may be tangible or non-transitory computer-readable storage media, such as Random Access Memory (RAM), Read Only Memory (ROM), a permanent mass storage device (such as a disk drive, solid state (e.g., NAND flash) device, etc.), and/or any other like data storage mechanism capable of storing and recording data. The one or more storage devices may be configured to store computer programs, program code, instructions, or some combination thereof, for one or more operating systems and/or for implementing some example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of some example embodiments, or they may be known devices that are altered and/or modified for the purposes of some example embodiments.

A hardware device, such as a computer processing device, may run an operating system (OS) and one or more software applications that run on the OS. The computer processing device also may access, store, manipulate, process, and create data in response to execution of the software. For simplicity, some example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of some example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

A request processing system according to some example embodiments may be implemented by at least one computer device. Here, a computer program according to some example embodiments may be installed and executed on the at least one computer device, and the at least one computer device may perform the request processing method according to some example embodiments under control of the executed computer program. The aforementioned computer program may be stored in a non-transitory computer-readable recording medium to computer-implement the request processing method in conjunction with the at least one computer device.

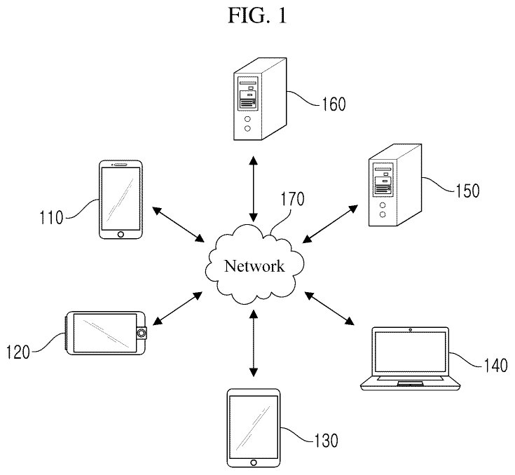

FIG. 1 illustrates an example of a network environment according to some example embodiments. Referring to FIG. 1, the network environment may include a plurality of electronic devices 110, 120, 130, and 140, a plurality of servers 150 and 160, and/or a network 170. FIG. 1 is provided as an example only. The number of electronic devices or the number of servers is not limited thereto. Also, the network environment of FIG. 1 describes one example among environments applicable to some example embodiments and an environment applicable to some example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, artificial intelligence (AI), a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless and/or wired communication manner. According to some example embodiments, operations described herein as being performed by each of the plurality of electronic devices 110, 120, 130, and 140 may be performed using processing circuitry.

The communication scheme is not limited and may include a near field wireless communication scheme between devices as well as a communication scheme using a communication network (e.g., mobile communication network, wired Internet, wireless Internet, broadcasting network, etc.) includable in the network 170. For example, the network 170 may include at least one of network topologies that include a Personal Area Network (PAN), a Local Area Network (LAN), a Campus Area Network (CAN), a Metropolitan Area Network (MAN), a Wide Area Network (WAN), a Broadband Network (BBN), the Internet, etc. Also, the network 170 may include at least one of network topologies that include a bus network, a star network, a ring network, a mesh network, a star-bus network, a tree or hierarchical network, and the like. However, these network topologies are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service to the plurality of electronic devices 110, 120, 130, and 140 connected over the network 170. According to some example embodiments, operations described herein as being performed by each of the plurality of servers 150 and 160 may be performed using processing circuitry.

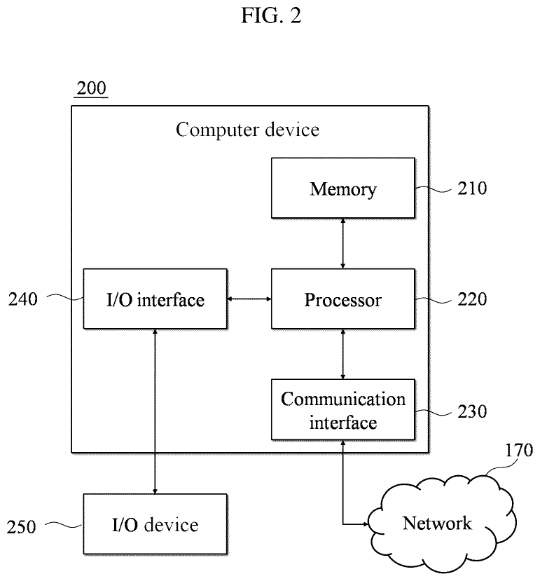

FIG. 2 is a block diagram illustrating an example of a computer device according to some example embodiments. Each of the plurality of electronic devices 110, 120, 130, and 140 of FIG. 1, and/or each of the servers 150 and 160, may be implemented by a computer device 200 of FIG. 2.

Referring to FIG. 2, the computer device 200 may include a memory 210, a processor 220, a communication interface 230, and/or an input/output (I/O) interface 240. The memory 210 may include a permanent mass storage device, such as a Random Access Memory (RAM), a Read Only Memory (ROM), and/or a disk drive, as a non-transitory computer-readable recording medium. The permanent mass storage device, such as a ROM and/or a disk drive, may be included in the computer device 200 as a permanent storage device separate from the memory 210. Also, an Operating System (OS) and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to some example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and/or I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another apparatus, for example, the aforementioned storage devices, over the network 170. For example, the processor 220 of the computer device 200 may forward a request or an instruction created based on a program code stored in the storage device such as the memory 210, data, and/or a file, to other apparatuses over the network 170 under control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and/or a file, etc., may be stored in a storage medium, for example, the permanent storage device, further includable in the computer device 200.

The I/O interface 240 may be a device used for interfacing with an I/O device 250. For example, the I/O device 250 may be an input device that may include a device, such as a microphone, a keyboard, a mouse, etc., and/or an output device that may include a device, such as a display, a speaker, etc. As another example, the I/O interface 240 may be a device for interfacing with an apparatus in which an input function and an output function are integrated into a single function, such as a touchscreen. At least one of the I/O device 250 may be configured as a single apparatus with the computer device 200. For example, it may be implemented in a form in which a touchscreen, a microphone, and a speaker are included in the computer device 200, such as a smartphone, and may also be implemented in a form in which a microphone and a speaker are included in the computer device 200, such as an artificial intelligence speaker.

Also, according to other example embodiments, the computer device 200 may include the number of components greater than or less than the number of components shown in FIG. 2. However, there is no need to clearly illustrate many components according to the related art. For example, the computer device 200 may include at least a portion of the I/O device 250, or may further include other components, for example, a transceiver, a database, etc. According to some example embodiments, operations described herein as being performed by the computer device 200, the processor 220, the communication interface 230, the I/O interface 240 and/or the I/O device 250 may be performed using processing circuitry.

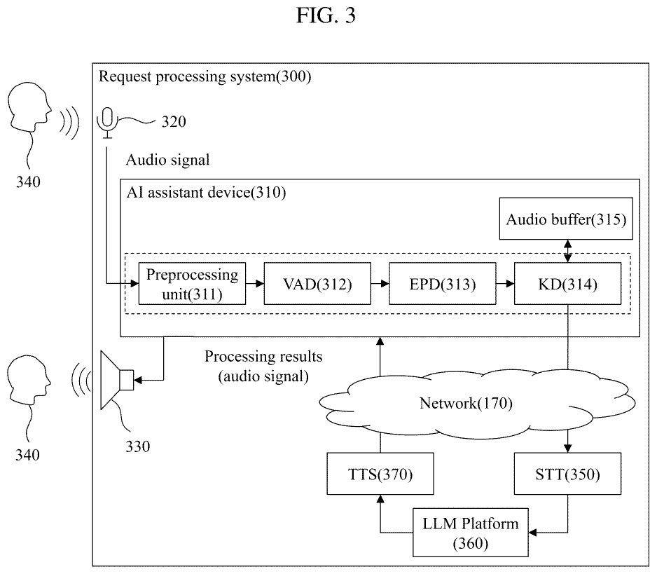

FIGS. 3 to 5 illustrate examples of an internal configuration of a request processing system according to some example embodiments. A request processing system 300 may include an artificial intelligence (AI) assistant device 310, 410, 510.

The AI assistant device 310, 410 and/or 510 refers to a device that basically includes a microphone 320 and a speaker 330, or is connected to the microphone 320 and the speaker 330, to process a request including an audio voice of a user 340 input through the microphone 320 through a Large Language Model (LLM) and to provide processing results as a voice through the speaker 330, and may be basically a stationary device, such as an artificial intelligence speaker installed in a home or a vehicle, but is not limited thereto. For example, any device capable of receiving and processing an audio voice of the user 340, including the speaker 330 and the microphone 320, such as a smartphone or a personal computer (PC), may be used as the AI assistant device 310, 410 and/or 510.

Also, the AI assistant device 310, 410 and/or 510 may basically include a preprocessing unit 311, a voice activation detector (VAD) 312, an end-point detector (EPD) 313, and/or a keyword detector (KD) 314.

The preprocessing unit 311 may perform preprocessing (or processing), such as removing noise, to recognize a voice signal in an audio signal input through the microphone 320. The preprocessing unit 311 may be implemented in hardware and/or software. For example, the preprocessing unit 311 may be implemented using hardware, such as a digital signal processor (DSP). The DSP refers to a special processor that is installed on various devices, such as a smartphone, a smart speaker, and/or a laptop computer, to quickly and efficiently process audio, video, and/or sensor data. In particular, the DSP is a processor optimized (or configured) for quickly performing real-time audio tasks, such as voice processing, noise reduction, and/or beamforming. The preprocessing unit 311 may preprocess (or process) an audio signal input through the microphone 320 using a software function to provide a DSP or DSP-like function. For example, the preprocessing unit 311 may perform far-field voice processing. In general, in a case in which the user 340 is speaking close to the microphone 320, sound may be recognized well. However, in a case in which the user 340 is speaking far away from the microphone 320, a recognition rate may decrease. Far-field voice processing refers to technology that allows a voice to be accurately recognized although the user 340 speaks from a distance. The preprocessing unit 311 may remove environmental noise and may extract an accurate voice by tracking a location of an uttering person using this far-field voice processing. As another example, the preprocessing unit 311 may include a microphone array beamforming function. If a plurality of microphones are installed in an array rather than a single microphone, a direction from which sound is emitted may be identified and the sound may be intensively listened to (or received), which is called beamforming. Beamforming is technology that forms a “beam” of sound and emphasizes only a sound coming from a specific direction. When the microphone 320 is configured as an array of a plurality of sub-microphones, the preprocessing unit 311 may reduce ambient noise and may more clearly extract a voice of an uttering person by utilizing the microphone 320 together with a virtual directional microphone using this microphone array beamforming function. As another example, the preprocessing unit 311 may cleanly transmit only the voice of the user 340 to a system using a noise removal function that reduces background noise in real time, such as music, TV sound, a voice of another person, wind noise, etc., contained in the audio signal. In detail, for example, the preprocessing unit 311 may separate a voice and noise from the audio signal and may remove only noise using frequency analysis or deep learning-based filtering technology.

The VAD 312 may recognize whether a voice signal is present in the audio signal received from the microphone 320 (e.g., a processed voice signal received from the microphone 320 via the preprocessing unit 311). For example, a lightweight VAD module included in WebRTC, which is a Real-Time Communication (RTC) opensource project, or a PyTorch-based deep learning VAD model may be utilized to recognize presence of the voice signal in the VAD 312.

The EPD 313 may detect whether the voice signal detected by the VAD 312 has ended and may separate voice data into sentence units. This may be a task of finding a start point and an end point of a sentence unit uttered by a person in the voice data.

The KD 314 may detect whether a preset (or otherwise, given or set) keyword (e.g., keyword preset (or otherwise, given or set) to call artificial intelligence speaker) is present in the detected voice data. Here, when the preset (or otherwise, given or set) keyword is present, the KD 314 may recognize voice data of the user 340 associated with the keyword as a request of the user 340. Depending on some example embodiments, voice data that does not include a specific keyword may also be recognized as the request of the user 340. For example, in some example embodiments described below, the AI assistant device 310 may include Speech-To-Text (STT) 350. In this case, the AI assistant device 310 may analyze text data converted through the STT 350 and may also detect voice data that includes the request of the user 340.

The AI assistant device 310 of FIG. 3 may include an audio buffer 315, and each of the AI assistant devices 410 and 510 may include a text buffer 420. The audio buffer 315 and the text buffer 420 may store an audio voice or text that is input prior to input of the voice data (request of the user 340) in which the preset (or alternatively, given or set) keyword is present. For example, the audio buffer 315 may store audio voice data that is input before the request of the user 340 is input, and the text buffer 420 may store text data converted to text from the audio voice data that is input before the request of the user 340 is input. Such a difference between the audio buffer 315 and the text buffer 420 appears since the AI assistant device 310 does not include the STT 350 and stores the audio voice data using the audio buffer 315, whereas each of the AI assistant devices 410 and 510 includes the STT 350 and is capable of directly storing the text data converted from the audio voice data to the text in the text buffer 420.

Prior to describing the audio buffer 315 and the text buffer 420 in detail, the STT 350, an LLM platform 360, and Text-To-Speech (TTS) 370 are initially described.

Since the LLM platform 360 operates based on not audio but text, the STT 350 may recognize a voice (sound) of the user 340 and may convert the same to text (character(s)). The converted text may be transmitted to and processed by the LLM platform 360. Here, the converted text may include the request of the user 340, and the request of the user 340 may be various, such as a question that requests an answer, processing of a specific function or processing of a specific operation associated with the LLM platform 360. The LLM platform 360 may process the request of the user 340 through inference using an LLM model and/or linkage to an external service. Here, the LLM platform 360 may also process the request of the user 340 by utilizing its own internal artificial intelligence model as the LLM model, but may also process the request of the user 340 by integrating an artificial intelligence model provided from the outside into an application of the LLM platform 360 based on an Application Programming Interface (API) access.

The LLM platform 360 may process the request of the user 340 based on the LLM model and may transmit processing results to the user 340 again. Here, to output the processing results using an audio signal through the speaker 330, the TTS 370 may be used. The TTS 370 may analyze the input text (character(s)) and may convert the same to a natural voice (sound). The processing results including the voice (audio signal) converted by the TTS 370 may be output for the user 340 through the speaker 330. The processing results may include an answer to a question of the user 340 or may include information on results of processing a function or an operation requested by the user 340.

In this voice-based processing process, a device such as a conventional artificial intelligence speaker transmits, to a server, an audio signal or converted text after a specific keyword is recognized and processes the request. Accordingly, the conventional artificial intelligence speaker may not convey context prior to the request.

To solve this issue, the AI assistant device 310, 410 and/or 510 according to some example embodiments may include the audio buffer 315 or the text buffer 420.

In some example embodiments, the AI assistant device 310 represents an example of a device that does not include the STT 350. Since the STT 350 is present outside the AI assistant device 310, the AI assistant device 310 may store audio data in units of syllables, words, and/or sentences in the audio buffer 315 through the preprocessing unit 311, the VAD 312, the EPD 313, and the KD 314. Some example embodiments of FIGS. 3 to 5 show only a single user 340, but audio data of two or more users may be stored in the audio buffer 315 in units of syllables, words, and/or sentences. In this case, if a specific keyword is recognized, the AI assistant device 310 may transmit audio data stored in the audio buffer 315 and audio data including the specific keyword to a server side (e.g., server that includes STT 350, LLM platform 360, and/or TTS 370). Here, the audio data may be transmitted to the server side in the order in which the audio data is input to the AI assistant device 310, or may be transmitted to the server side together with information indicating the input order. Depending on some example embodiments, the specific keyword corresponding to the request of the user 340 may be excluded (e.g., removed) from the audio data transmitted to the server side. Here, the AI assistant device 310 may remove, from the audio buffer 315, the audio data of which transmission to the server side is completed. The LLM platform 360 may receive not only the audio data including the specific keyword (e.g., audio data including request of user 340) but also audio data that is input before the corresponding audio data is input, and may process the request of the user 340 to be suitable for the context based on the LLM model. For example, the LLM platform 360 may generate and provide an answer to a question of the user 340 by verifying the context of a previous conversion. As used herein, the server side may also be referred to and/or implemented as a server.

The following Table 2 shows an example of transmitted audio data and processing results thereof.

TABLE 1

| | |
|---|---|
| Previous | User A: How about traveling to Japan in April? |
| conversation | User B: Okay. How about going to Tokyo this time? |
| between | User A: How about Osaka? |
| users | |
| Request of | ABC! What do you think? |
| user A | |
| Processing | Traveling to Japan in April is a great choice in many ways. |
| results | The weather is warm and pleasant during this time, and |
| | cherry blossoms are in full bloom, creating beautiful |
| | scenery. Both Tokyo and Osaka have their own charms, so |
| | no matter which you choose, you will have a satisfying trip. |
| | Below, I will summarize advantages of traveling to both |
| | cities in April. |
| | Advantages of Tokyo: |
| | (omitted) |
| | Advantages of Osaka: |
| | (omitted) |

That is, in the case of using a device such as conventional artificial intelligence speaker, only audio data corresponding to the request “ABC! What do you think?” of user A that includes a specific keyword (“ABC” in the example of Table 1) is transmitted to the server, so it is difficult to determine the intent of user A and accordingly, an additional inquiry (inquiry from artificial intelligence model) for verifying the intent of user A and an answer from user A to the inquiry are required (or otherwise, performed).

On the other hand, since the AI assistant device 310 according to the example of FIG. 3 further transmits previously input audio data, from which a previous conversational context may be inferred, to the server side using the audio buffer 315, an answer may be immediately (or promptly) provided as shown in Table 1 without requiring (or otherwise, performing) an additional inquiry and answer. Then, processing results of the LLM platform 360 for the request of the user 340 may be converted to an audio signal through the TTS 370 and transmitted to the AI assistant device 410, and the AI assistant device 410 may output the transmitted audio signal through the speaker 330.

To prevent audio data with the context different from the request of the user 340 from being transmitted to the server side (or reduce the occurrence thereof), the AI assistant device 310 may periodically remove, from the audio buffer 315, audio data (e.g., a subset of the audio data) having passed (e.g., that has been stored in the audio buffer 315 beyond) a certain period of time among audio data stored in the audio buffer 315.

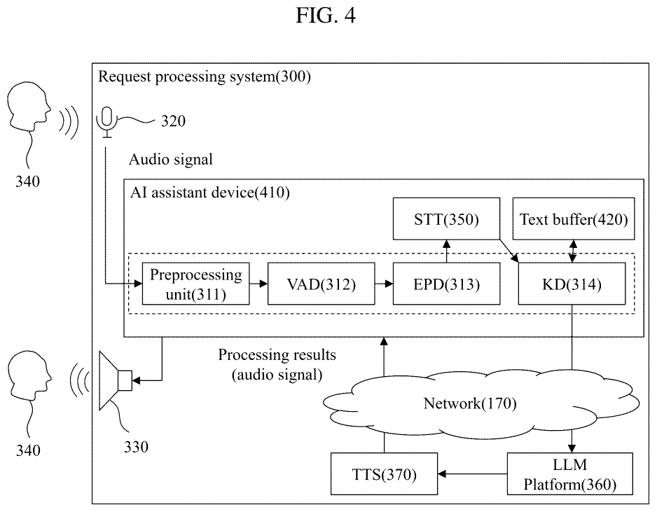

In the example of FIG. 4, the AI assistant device 410 represents an example of a device that directly includes the STT 350. In this case, since the STT 350 is located inside the AI assistant device 410, the AI assistant device 410 may store text data in units of syllables, words, and/or sentences in the text buffer 420 through the STT 350 between the EPD 313 and the DK 314, as well as the preprocessing unit 311, the VAD 312, the EPD 313, and the KD 314. Here, unlike the audio data, when the text data is stored in the text buffer 420, the AI assistant device 410 may identify context and/or an utterer (e.g., the user 240) and may store the text data in the text buffer 420.

Even in this case, when a specific keyword is recognized, the AI assistant device 410 may transmit the text data stored in the text buffer 420 and text data including the specific keyword to the server side (e.g., server that includes LLM platform 360 and/or TTS 370). Here, the text data may be transmitted to the server side in the order in which the text data is input to the AI assistant device 410, or may be transmitted to the server side together with information indicating the input order. Depending on some example embodiments, the specific keyword corresponding to the request of the user 340 may be excluded (e.g., removed) from the text data transmitted to the server side. Here, the AI assistant device 410 may remove, from the text buffer 420, the text data of which transmission to the server side is completed (e.g., in response to the transmitting to the server). The LLM platform 360 may receive not only the text data including the specific keyword (e.g., text data including request of user 340) but also text data that is input before the corresponding text data is input, and may process the request of the user 340 to be suitable for the context based on the LLM model. For example, the LLM platform 360 may generate and provide an answer to a question of the user 340 by verifying the context of previous conversation. Then, the processing results of the LLM platform 360 that processes the request of the user 340 may be converted to an audio signal through the TTS 370 and transmitted to the AI assistant device 410, and the AI assistant device 410 may output the transmitted audio signal through the speaker 330.

When the AI assistant device 410 identifies the context and/or an utterer (e.g., the user 340) and stores text data in the text buffer 420, only text data of the context and/or utterer related to the request of the user 340 may be extracted from the text buffer 420 and transmitted to the server side. Even in this case, all the text data stored in the text buffer 420 may be removed.

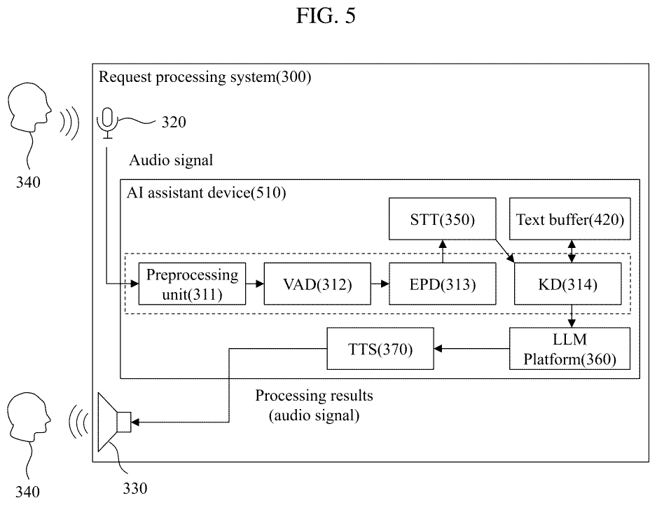

In the example of FIG. 5, the AI assistant device 510 represents an example of a device that directly includes the LLM platform 360 and the TTS 370 as well as the STT 350. In this case, since the STT 350 is located inside the AI assistant device 510, the AI assistant device 510 may store text data in units of syllables, words, and/or sentences in the text buffer 420 through the STT 350 between the EPD 313 and the DK 314, as well as the preprocessing unit 311, the VAD 312, the EPD 313, and the KD 314. Here, unlike the audio data, when the text data is stored in the text buffer 420, the AI assistant device 510 may identify context and/or an utterer (e.g., the user 340) and may store the text data in the text buffer 420.

In this case, when a specific keyword is recognized, the AI assistant device 510 may transmit (e.g., provide) the text data stored in the text buffer 420 and text data including the specific keyword to the LLM platform 360. Here, the text data may be transmitted (e.g., provided) to the LLM platform 360 in the order in which the text data is input to the AI assistant device 510, or may be transmitted to the LLM platform 360 together with information indicating the input order. In this case, the specific keyword corresponding to the request of the user 340 may be excluded (e.g., removed) from the text data transmitted (e.g., provided) to the LLM platform 360. Here, the AI assistant device 510 may remove, from the text buffer 420, the text data of which transmission to the LLM platform 360 is completed (e.g., in response to the transmitting to the server). The LLM platform 360 may receive not only the text data including the specific keyword (e.g., text data including request of user 340) but also text data that is input before the text data is input, and may process the request of the user 340 to be suitable for the context based on the LLM model. For example, the LLM platform 360 may generate and provide an answer to a question of the user 340 by verifying the context of previous conversation. Then, the processing results of the LLM platform 360 that processes the request of the user 340 may be converted to an audio signal through the TTS 370, and may be output through the speaker 330.

When the AI assistant device 510 identifies the context and/or an utterer (e.g., the user 340) and stores text data in the text buffer 420, only text data of the context and/or utterer related to the request of the user 340 may be extracted from the text buffer 420 and transmitted to the LLM platform 360. Even in this case, all the text data stored in the text buffer 420 may be removed.

As described above, the configuration and operation of each of the AI assistant devices 310, 410, and/or 510 may differ depending on where the STT 350 and the LLM platform 360 are located. For example, an on-device mode may represent a case in which an edge end, such as the AI assistant device 510, includes both the STT 350 and the LLM platform 360. Also, an appliance mode may represent a case in which the STT 350 and/or the LLM platform 360 are located in an appliance on a local network, such as a legacy system of a cloud capable of performing on-premise interaction or a main processor of a vehicle. In this case, both the AI assistant device 410 that includes the STT 350 and the AI assistant device 410 that does not include the STT 350 may be considered. Also, a cloud mode may represent a case in which the cloud includes the LLM platform 360. Even in this case, both the AI assistant device 410 that includes the STT 350 and the AI assistant device 410 that does not include the STT 350 may be considered.

According to some example embodiments, each of the AI assistant devices 310, 410, and/or 510 may be implemented using the computer device 200. According to some example embodiments, each of the AI assistant devices 310, 410, and/or 510 may be implemented by one or more among the plurality of electronic devices 110, 120, 130, and 140, and the server-side may be implemented by one or more among the plurality of servers 150 and 160. According to some example embodiments, operations described herein as being performed by the request processing system 300, the AI assistance device 310, the AI assistant device 410, the AI assistant device 510, the preprocessing unit 311, the VAD 312, the EPD 313, the KD 314, the STT 350, the LLM platform 360 and/or the TTS 370 may be implemented using processing circuitry. According to some example embodiments, the audio buffer 315 and/or the text buffer 420 may be implemented using a non-transitory computer readable medium.

According to some example embodiments, the processing circuitry may perform some operations (e.g., the operations described herein as being performed by the LLM platform 360) by artificial intelligence and/or machine learning. As an example, the processing circuitry may implement an artificial neural network (e.g., the LLM platform 360) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

The server side may correspond to the server 150, or 160 described above through FIG. 1, and may be implemented by at least one computer device. In this case, each of the at least one computer devices may be implemented like the computer device 200 described through FIG. 2. In the embodiment of FIG. 3, the server side may include an STT 350, an LLM platform 360, and a TTS 370, and in the embodiment of FIG. 4, the server side may include an LLM platform 360 and a TTS 370. As described above, in the embodiment of FIG. 5, since the AI assistant device 510 may directly include not only the STT 350 but also the LLM platform 360 and the TTS 370, a separate server may not be required.

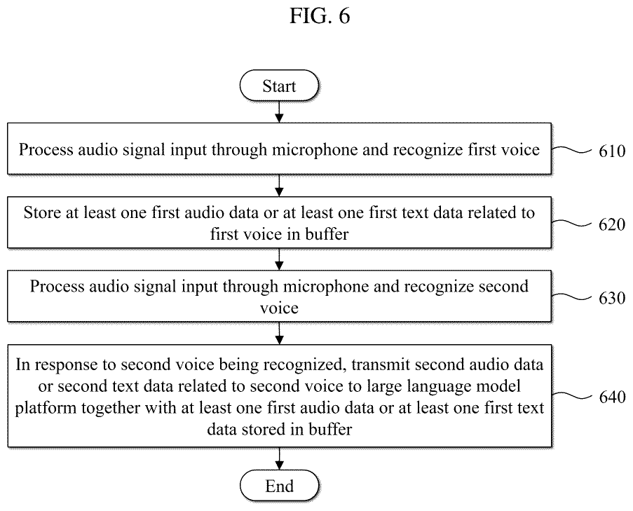

FIG. 6 is a flowchart illustrating an example of a request processing method of a request processing system according to some example embodiments. The request processing method according to some example embodiments may be performed by the request processing system 300 implemented by at least one computer device. Here, each of the at least one computer device may correspond to the computer device 200 described above with reference to FIG. 2. For example, the processor 220 included in the computer device 200 may be implemented to execute a control instruction according to a code of an OS included in the memory 210 and/or a code of at least one computer program. Here, the processor 220 may operate according to a control instruction provided from a code stored in the computer device 200 and may control the request processing system 300 such that the request processing system 300 implemented by the computer device 200 may perform operations 610 to 640 included in the method of FIG. 6. Substantially, operations 610 to 640 included in the example of FIG. 6 may be performed by an AI assistant device (e.g., AI assistant device 310, 410, or 510) that may be included in the request processing system 300.

In operation 610, the request processing system 300 may process an audio signal input through a microphone and may recognize a first voice. Here, the microphone may correspond to the aforementioned microphone 320, and processing of recognizing the first voice may include processing using the preprocessing unit 311, the VAD 312, the EPD 313, and/or the KD 314. Here, the first voice may be assumed as a voice that does not contain a preset (or alternatively, given or set) keyword (e.g., at least one word preset (or alternatively, given or set) to wake up LLM-based service of the computer device 200 such as an artificial intelligence speaker or a smartphone). Here, the request processing system 300 may periodically remove, from a buffer, first audio data (e.g., a subset of the first audio data) or first text data (e.g., a subset of the first text data) that has passed (e.g., that has been stored in the buffer beyond) a certain period of time among at least one first audio data or at least one first text data stored in the buffer.

In operation 620, the request processing system 300 may store at least one first audio data (e.g., at least one piece of first audio data) or at least one first text data (e.g., at least one piece of first text data) related to the first voice in a buffer. Here, the buffer may correspond to the audio buffer 315 when storing audio data, and may correspond to the text buffer 420 when storing text data.

In operation 630, the request processing system 300 may process the audio signal input through the microphone and may recognize a second voice. For example, the request processing system 300 may assume a voice including a preset (or alternatively, given or set) keyword in the audio signal as the second voice including a request of a user (e.g., user 340). As another example, although a voice does not include a specific keyword, the voice may be determined to include the request of the user and in this case, the request processing system 300 may recognize the voice as the second voice. In this case, the request processing system 300 may include a configuration for determining whether the voice includes the request of the user. For example, when the request processing system 300 analyzes a voice converted to text using the STT 350 and the voice is determined to include the request of the user, the request processing system 300 may recognize the voice as the second voice. As another example, the request processing system 300 may recognize a voice after the voice including the preset (or alternatively, given or set) keyword is recognized, as the second voice.

In operation 640, in response to the second voice being recognized, the request processing system 300 may transmit second audio data, or second text data related to the second voice, to a large language model platform together with the at least one first audio data or the at least one first text data stored in the buffer. Here, the large language model platform may correspond to the LLM platform 360. The request processing system 300 may transmit the at least one first audio data or the at least one first text data stored in the buffer to the large language model platform in operation 640 and then, may remove the at least one first audio data or the at least one first text data from the buffer (e.g., in response to the transmitting).

Also, in the case of storing the text data in the buffer in operation 610, that is, in the case of storing the at least one first text data in the buffer, the request processing system 300 may analyze the at least one first text data, may identify at least one of the context and an utterer (may also be referred to herein as third text data among the first text data), and may store the at least one first text data in the buffer. In this case, the request processing system 300 may extract first text data of the context or the utterer (e.g., a subset of the third text data) related to the second text data from among the at least one first text data stored in the buffer and may transmit the extracted first text data (e.g., the subset of the third text data) to the large language model platform together with the second text data. For example, the AI assistant device 410, and/or 510 can distinguish a speaker based on voice biometrics technology. For example, the AI assistant device 310, 410, and/or 510 can identify a speaker by analyzing acoustic characteristics such as voice tone, vocalization habits, speech speed, and intonation that are unique to each person. As a more specific example, when a user first registers with the AI assistant device 310, 410, and/or 510, a speaker profile can be created by recording a pre-determined sentence or a voice of a certain length. Thereafter, the AI assistant device 410, and/or 510 can identify who the speaker is by comparing voice data input in real time with this profile. This comparison can be performed through an acoustic model and a deep learning-based speaker recognition model (e.g., speaker embedding, d-vector, x-vector, etc.). In addition, depending on the embodiment, the AI assistant device 410, and/or 510 can increase the accuracy of speaker identification by combining user accounts or personalized settings (e.g., speech patterns, frequently used words, etc.) with voice recognition. In this way, the AI assistant device 410, and/or 510 can effectively distinguish speakers even in an environment with multiple users by learning and comparing unique characteristics of the user's voice. In addition, the AI assistant device 410, and/or 510 can comprehensively analyze the flow of conversation, previous utterances, situational information such as time and place, and directives (e.g., “at that time”, “that person”) to distinguish the context. The AI assistant device 410, and/or 510 can convert each user's utterance into text, store it in chronological order, and analyze the relevance to the previous utterance. For example, if there is an utterance such as “I have a meeting at 2 PM tomorrow” and then “Set an alarm for then,” the AI assistant device 410, and/or 510 can recognize that the directive “then” means “tomorrow at 2 PM” in the preceding sentence. In addition, the AI assistant device 510 can perform natural language processing (NLP) using the LLM 360 and extract meaning units (events, times, places, objects, etc.) included in each sentence to identify the relationship between contexts. If necessary, external information such as schedules, user preferences, and peripheral device status can also be utilized to determine the context. In this way, the AI assistant device 410, and/or 510 can identify the context according to the user's intention by understanding and remembering the entire flow of a continuous conversation, not a single utterance.

Also, depending on some example embodiments, in operation 640, the request processing system 300 may remove the preset (or alternatively, given or set) keyword included in the second audio data or the second text data and may transmit the same to the large language model platform. This approach may be utilized when recognizing the voice including the corresponding keyword as the second voice in operation 630.

When both the STT 350 and the LLM platform 360 are located outside (e.g., appliance connected to server side or local network), the request processing system 300 may store the at least one first audio data related to the first voice in the buffer (in this case, audio buffer 315). Here, in operation 640, the request processing system 300 may transmit the second audio data related to the second voice to a server side that communicates with the computer device 200 over a network (e.g., network 170) and includes the large language model platform, together with the at least one first audio data stored in the buffer. In this case, the server side may convert each of the at least one first audio data and the second audio data transmitted from the computer device 200 over the network to text using the STT 350, and may input the converted text to the large language model platform to process the request of the user according to the second audio data according to the context based on the at least one first audio data. For example, if the server side extracts the context “I have a meeting at 3 PM tomorrow” from the user's first audio data, and extracts the request of the user “Set an alarm for that time” from the second audio data, the server side can process the request of the user according to the context, meaning “Set an alarm for 3 PM tomorrow.” In addition, Table 1 above provides an example of how LLM processes user requests according to context. Then, the server side may generate processing results according to processing the request of the user and may provide the processing results to the computer device 200 over the network. In this case, the processing results may be converted to an audio signal at the server side through the TTS 370 and then provided to the computer device 200, and the computer device 200 may output the provided audio signal through a speaker (e.g., speaker 330) and may provide the processing results to the user as a voice.

According to some example embodiments, the audio signal (e.g., an output audio signal) representing the processing results may be transformed into corresponding sound wave using the speaker 330 (e.g., a loudspeaker). For example, the audio signal may be represented as a time-varying voltage signal input to the speaker 330. A voice coil of the speaker 330 suspended in a magnetic field may be caused to physically move back and forth according to the time-varying voltage signal. This movement of the voice coil may cause vibrations in a diaphragm of the speaker 330, thereby creating sound wave representative of the audio signal corresponding to the processing results.

When the STT 350 is located inside the computer device 200 and the LLM platform 360 is located outside the computer device 200, the request processing system 300 may convert each of the at least one first audio data related to the first voice to text using the STT 350, may generate the at least one first text data related to the first voice, and may store the generated at least one first text data in the buffer (in this case, text buffer 420). Here, in operation 640, the request processing system 300 may convert the second audio data related to the second voice to text using the STT 350, may generate the second text data related to the second voice, and may transmit the generated second text data to a server side that communicates with the computer device 200 and includes the large language model platform, together with the at least one first text data stored in the buffer. In this case, the server side may input the at least one first text data and the second text data transmitted from the computer device 200 over the network to the large language model platform to process the request of the user according to the second text data according to the context based on the at least one first text data, may generate processing results according to processing the request of the user, and may provide the processing results to the computer device 200 over the network. Even in this case, the processing results may be converted to an audio signal at the server side through the TTS 370 and then, provided to the computer device 200, and the computer device 200 may output the provided audio signal through the speaker (e.g., speaker 330) and may provide the processing results to the user as a voice.

When both the STT 350 and the LLM platform 360 are located inside the computer device 200, the request processing system 300 may convert each of the at least one first audio data related to the first voice to text using the STT 350, may generate the at least one first text data related to the first voice, and may store the generated at least one first text data in the buffer (even in this case, text buffer 420) in operation 620. Here, in operation 640, the request processing system 300 may convert the second audio data related to the second voice to text using the STT 350, may generate the second text data related to the second voice, and may transmit the generated second text data to the large language model platform that is further included in the computer device 200, together with the at least one first text data stored in the buffer. In this case, the computer device 200 may input the at least one first text data and the second text data to the large language model platform included in the computer device 200 to process the request of the user according to the second text data according to the context based on the at least one first text data. Also, the computer device 200 may generate processing results according to processing the request of the user and may output the same through the speaker and may provide the processing results to the user as a voice.

According to some example embodiments, it is possible to provide a method and system for processing a request using an artificial intelligence assistant device based on a large language model.

The systems or the apparatuses described herein may be implemented using hardware components, software components, and/or the combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and/or create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, or non-transitory computer storage medium or device, to be interpreted by the processing device or to provide instructions or data to the processing device. The software also may be distributed over network coupled computer systems so that the software is stored and executed in a distributed fashion. The software and data may be stored by one or more non-transitory computer readable recording mediums.

The methods according to some example embodiments may be recorded in non-transitory computer-readable media including program instructions executable through various computer methods. The media may include, alone or in combination with program instructions, data files, and/or data structures. The media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of the media include magnetic media such as hard disks, floppy disks, and magnetic tapes; optical media such as CD ROM disks and DVDs; magneto-optical media such as floptical disks; and hardware devices that are specially designed to store and perform program instructions, such as Read-Only Memory (ROM), Random Access Memory (RAM), flash memory, and the like. Examples of other media may include recording media and storage media managed by an app store that distributes applications or a site, a server, and the like that supplies and distributes other various types of software. Examples of the program instruction include not only a machine language code as produced by a compiler but also an advanced language code executable by a computer using an interpreter.

The foregoing description has been provided for purposes of illustration and description. It is not intended to be exhaustive or to limit the disclosure. Individual elements or features of a particular example are generally not limited to that particular example, but, where applicable, are interchangeable and may be used in a selected example, even if not specifically shown or described. The same may also be varied in many ways. Such variations are not to be regarded as a departure from the disclosure, and all such modifications are intended to be included within the scope of the disclosure.

What is claimed is:

1. A request processing method of a request processing system, the request processing system being implemented by at least one computer device, the at least one computer device including at least one processor, and the request processing method comprising:
processing, by the at least one processor, an audio signal input through a microphone;
recognizing, by the at least one processor, a first voice in the audio signal;
storing, by the at least one processor, first audio data or first text data in a buffer, the first audio data or the first text data being related to the first voice;
recognizing, by the at least one processor, a second voice in the audio signal; and
transmitting, by the at least one processor, second audio data or second text data together with the first audio data or the first text data to a large language model platform in response to the recognizing the second voice, the second audio data or the second text data being related to the second voice.

2. The request processing method of claim 1, wherein
the storing includes storing the first audio data in the buffer; and
the transmitting includes transmitting the second audio data and the first audio data to a server over a network, the server including the large language model platform.

3. The request processing method of claim 2, wherein the server is configured to:
convert each of the first audio data and the second audio data to text using speech-to-text (STT) to obtain converted text;
input the converted text to the large language model platform to process a request of a user according to a context, the request of the user corresponding to the second audio data, and the context corresponding to the first audio data;
generate processing results according to processing the request of the user; and
provide the processing results to the at least one computer device over the network.

4. The request processing method of claim 1, wherein
the storing includes,
converting the first audio data to text using speech-to-text (STT) to generate the first text data, and
storing the first text data in the buffer; and
the transmitting includes,
converting the second audio data to text using the STT to generate the second text data, and
transmitting the second text data and the first text data to a server over a network, the server including the large language model platform.

5. The request processing method of claim 4, wherein the server is configured to:
input the first text data and the second text data to the large language model platform to process a request of a user according to a context, the request of the user corresponding to the second text data, and the context corresponding to the first text data; and
generate processing results according to processing the request of the user; and
provide the processing results to the at least one computer device over the network.

6. The request processing method of claim 1, wherein
the large language model platform is included in the at least one computer device;
the storing includes,
converting the first audio data to text using speech-to-text (STT) to generate the first text data, and
storing the first text data in the buffer; and
the transmitting includes,
converting the second audio data to text using the STT to generate the second text data, and
transmitting the second text data and the first text data to the large language model platform.

7. The request processing method of claim 6, wherein the request processing method further comprises:
inputting, by the at least one processor, the first text data and the second text data to the large language model platform to process a request of a user according to a context, the request of the user corresponding to the second text data, and the context corresponding to the first text data;
generating, by the at least one processor, processing results according to processing the request of the user; and
outputting the processing results through a speaker.

8. The request processing method of claim 1, wherein the request processing method further comprises:
periodically removing from the buffer, a subset of the first audio data or a subset of the first text data that has been stored in the buffer beyond a certain period of time.

9. The request processing method of claim 1, wherein the request processing method further comprises:
removing the first audio data or the first text data from the buffer in response to the transmitting.

10. The request processing method of claim 1, wherein
the storing includes storing the first text data in the buffer;
the request processing method further comprises,
analyzing the first text data to identify third text data including at least one of context or an utterer, and
extracting a subset of the third text data related to the second text data; and
the transmitting includes transmitting the second text data and the subset of the third text data to the large language model platform.

11. The request processing method of claim 1, wherein
the recognizing the second voice includes recognizing a voice that includes a set keyword in the audio signal as the second voice; and
the transmitting includes transmitting the second audio data or the second text data from which the set keyword is removed to the large language model platform.

12. A non-transitory computer-readable recording medium storing instructions that, when executed by at least one processor, cause the at least one processor to execute the method of claim 1 on the at least one computer device.

13. A request processing system implemented by at least one computer device, the at least one computer device comprising:
at least one processor configured to cause the request processing system to,
process an audio signal input through a microphone,
recognize a first voice in the audio signal,
store first audio data or first text data in a buffer, the first audio data or the first text data being related to the first voice,
recognize a second voice in the audio signal, and
transmit second audio data or second text data together with the first audio data or the first text data a large language model platform in response to recognizing the second voice, the second audio data or the second text data being related to the second voice.

14. The request processing system of claim 13, wherein the at least one processor is configured to cause the request processing system to:
store the first audio data in the buffer; and
transmit the second audio data and the first audio data to a server over a network, the server including the large language model platform.

15. The request processing system of claim 14, wherein the server is configured to:
convert each of the first audio data and the second audio data to text using speech-to-text (STT) to obtain converted text;
input the converted text to the large language model platform to process a request of a user according to a context, the request of the user corresponding to the second audio data, and the context corresponding to the first audio data;
generate processing results according to processing the request of the user; and
provide the processing results to the at least one computer device over the network.

16. The request processing system of claim 13, wherein the at least one processor is configured to cause the request processing system to:
convert the first audio data to text using speech-to-text (STT) to generate the first text data;
store the first text data in the buffer;
convert the second audio data to text using the STT to generate the second text data; and
transmit the second text data and the first text data to a server over a network, the server including the large language model platform.

17. The request processing system of claim 16, wherein the server is configured to,
input the first text data and the second text data to the large language model platform to process a request of a user according to a context, the request of the user corresponding to the second text data, and the context corresponding to the first text data;
generate processing results according to processing the request of the user; and
provide the processing results to the at least one computer device over the network.

18. The request processing system of claim 13, wherein
the at least one computer device includes the large language model platform; and
the at least one processor is configured to cause the request processing system to:
convert the first audio data to text using speech-to-text (STT) to generate the first text data,
store the first text data in the buffer,
convert the second audio data to text using the STT to generate the second text data, and
transmit the second text data and the first text data to the large language model platform.

19. The request processing system of claim 18, wherein the at least one processor is configured to cause the request processing system to:
input the first text data and the second text data to the large language model platform to process a request of a user according to a context, the request of the user corresponding to the second text data, and the context corresponding to the first text data;
generate processing results according to processing the request of the user; and
output the processing results through a speaker.

20. The request processing system of claim 18, wherein the at least one computer device includes a speaker configured to cause the request processing system to:
convert a voltage signal into sound waves, the voltage signal being obtained based on an output of the large language model platform corresponding to the second audio data or the second text data and the first audio data or the first text data, and the sound waves being representative of an output audio signal corresponding to the output of the large language model platform.
